(19) United States
(12) Patent Application Publication
(10) Pub. No.: US 2006/0079360 A1
(43) Pub. Date: Apr. 13, 2006

(54) Belt tensioning device with high damping rate

(76) Inventors: Manfred Jung, Westerburg (DE); Simon Pfeifer, Plettenberg (DE); Joachim Jud, Daaden (DE); Thomas Berndt, Hof (DE); Jochen Asbeck, Attendorn (DE); Rudolf Berger, Simmerath (DE)

Correspondence Address: Wyatt, Gerber & O'Rourke, LLP, 99 Park Avenue, New York, NY, 10016, US

(21) Appl. No.: 11/237,123

(22) Filed: Sep. 28, 2005

(30) Foreign Application Priority Data
Sep. 28, 2004 (DE) 10 2004 047422.2

(51) Int. Cl. F16H 7/12

(52) U.S. Cl. 474/135; 474/133; 474/138

(57) ABSTRACT

A belt tensioning device having a substantially cylindrical receiving housing and a hub coaxially arranged therein. The receiving housing and the hub are supported so as to be rotatable relative to one another as well as supported by a helical torsion spring so as to be pretensioned relative to one another. A damping device is provided which comprises a circumferentially slotted damping bush and a strip spring adapted to the damping bush, wherein the damping bush rests against the inside of the receiving housing. The strip spring is arranged between the damping bush and the torsion spring. The strip spring and the torsion spring are connected in series, wherein one of the two is supported on the receiving housing and the other one of the two on the hub.

### BACKGROUND OF THE INVENTION

The invention relates to a belt tensioning device having a substantially cylindrical receiving housing and a hub coaxially arranged therein. The receiving housing and the hub are supported so as to be rotatable relative to one another as well as supported by a helical torsion spring so as to be pretensioned relative to one another, and having a damping device which comprises a circumferentially slotted damping bush and a strip spring adapted to the damping bush.

A belt tensioning device of this type is known from the German Patent Publication DE 101 31 916 A1. Here the strip spring encloses the damping bush, with both being arranged at a distance from the helical torsion spring which is positioned on a larger radius and is connected in a rotationally fast way to the receiving housing on the one hand and the hub on the other hand. The spring force of the torsion spring is transmitted via a roller carrier and a roller in the form of a pretensioning force to a tensioning belt, with the damping mechanism having the task of claming the spring/mass system and of avoiding undesirable belt vibrations. The damping effect in this case is clearly asymmetric, and with a tightening strip spring there occurs a higher damping rate and with an opening strip spring there occurs a lower damping rate. In many cases, the belt tensioning device of this type can achieve satisfactory damping rates.

### OBJECT OF THE INVENTION

The object of the present invention is to propose a belt tensioning device which, while comprising an extremely compact design, ensures a particularly high damping rate which is urgently required. In view of the present trend of having charged engines with a small piston displacement in connection with a very high performance rate and a highly non-uniform crankshaft rotation.

### SUMMARY OF THE INVENTION

The objective is achieved by providing a belt tensioning device of the initially mentioned type which is characterized in that the damping bush rests against the inside of the receiving housing. The strip spring is arranged between the damping bush and the torsion spring and the strip spring and the torsion spring are connected in series, wherein one of the two is supported on the receiving housing and the other one of the two on the hub.

The means described here ensure a compact shape with a very small housing diameter. As compared to prior art solutions, the invention requires only a small number of components, so that the production costs are highly advantageous. The axial position of the damping device can vary, so that heat dissipation can be effected either via the housing base or via a cover at the hub. As will be described in detail in connection with the drawings, a free end of the helical torsion spring is supported in a play-free way on an angled free end of the strip spring, thus effecting a transmission of force in a tangential direction with reference to the housing axis in order to increase the radial contact pressure force of the strip spring relative to the damping bush. The latter preferably is made of plastic. The strip spring itself is designed in such a way that it is used with a predetermined calculated pretension, thus applying a largely constant radial force radially outwardly to the damping bush. The pretensioned torsion spring, too, is tightened radially and applies radial forces to the damping sleeve. The total friction decisive for the damping effect thus consists of two separately settable and definable factors:
the radial and constant spring force of the strip spring and
the supporting forces of the helical torsion spring.

In view of the selected arrangement of movable and stationary components, there occurs a damping effect which is asymmetric relative to the direction of rotation, such as it is known from prior art belt tensioning devices.

In the preferred embodiment, the receiving housing comprises screwing means for being fixed to a machine component, and the roller carrier which is movable around the axis of rotation is connected to the hub.

The hub is preferably integrally connected to a housing cover which closes the receiving housing. At one spring end, the strip spring can engage the housing cover by means of an engaging lug formed on to the strip spring. As already mentioned, the strip spring, at its free end, is supported on the free end of the torsion spring which, in turn, by means of its free end, is supported in a form-fitting and positive way on the receiving housing. The two springs are built in under pretension, with the relative rotational movement between the hub on the one hand and the receiving housing on the other hand, being limited by mutual abutment means. This abutment means, more particularly, is provided directly at the receiving housing on the one hand and at the housing cover connected to the hub on the other hand. Between the hub and the respective bearing journal at the receiving housing, there is preferably arranged a friction-reducing bearing bush.

A belt tensioning device of the type described makes it possible to achieve damping values greater than 50%, i.e. the amplitude value of damping (Nm)—with reference to the spring pretension in the nominal position (Nm)—is to be greater than 50%.

### BRIEF DESCRIPTION OF THE DRAWINGS

A preferred embodiment of an inventive belt tensioning device is illustrated in the drawings and will be described below.

FIG. 1 illustrates the belt tensioning device in a cross-section through the axis of rotation.

FIG. 2 illustrates the inventive belt tensioning device in an exploded view in a first perspective.

FIG. 3 illustrates the inventive belt tensioning device in an exploded view in a second perspective.

FIG. 4 illustrates the hub and the housing cover with holding devices for the tensioning rollers.

FIG. 5 illustrates the inventive belt tensioning device in an assembled condition in a partial section.

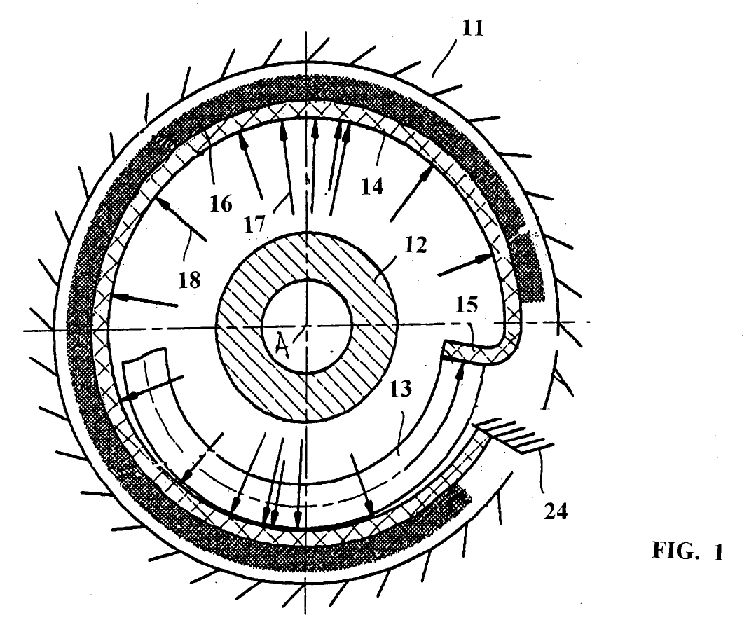

FIG. 1 illustrates the belt tensioning device with a substantially cylindrical receiving housing 11 and a hub 12 arranged therein. The receiving housing 11 and the hub 12, with reference to the axis A, are arranged concentrically relative to one another and so as to be rotatable relative to one another. The hub 12 is supported on a journal which is directly connected to the housing. The receiving housing 11 and the hub 12 are pretensioned relative to one another via a helical torsion spring 13, with only one free end of the torsion spring being shown. The other end which is not shown is supported in the receiving housing 11 so as to be rotationally fast. The visible free end of the torsion spring 13 is supported on a strip spring 14 whose free end 15 is bent inwardly and whose other end is secured in a rotationally fast way to a fixed cover part 24, more particularly to a cover part 24 which is firmly connected to the hub 12. In this way, the torsion spring 13 and the strip spring 14 are connected in series between the receiving housing 11 and the hub 12. The springs are pretensioned so as to be radially tightened. Outside the strip spring 14, there is positioned a damping sleeve 16 which is radially loaded indirectly by the torsion spring 13 and directly by the strip spring 14. The damping sleeve 16 on its outside, is supported in the receiving housing 11. The forces applied by the torsion spring 13 to the damping sleeve 16 are illustrated by longer arrows 17, which forces substantially acts on two radially opposed sides. Shorter arrows 18 indicate the substantially uniformly circumferentially distributed forces of the strip spring 14 which act on the damping sleeve 16.

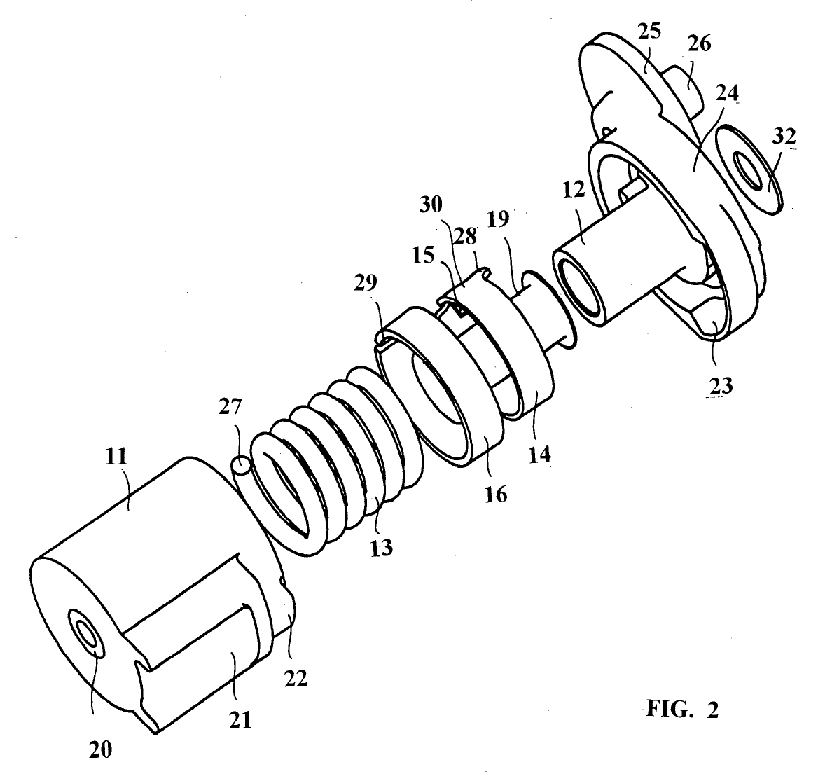

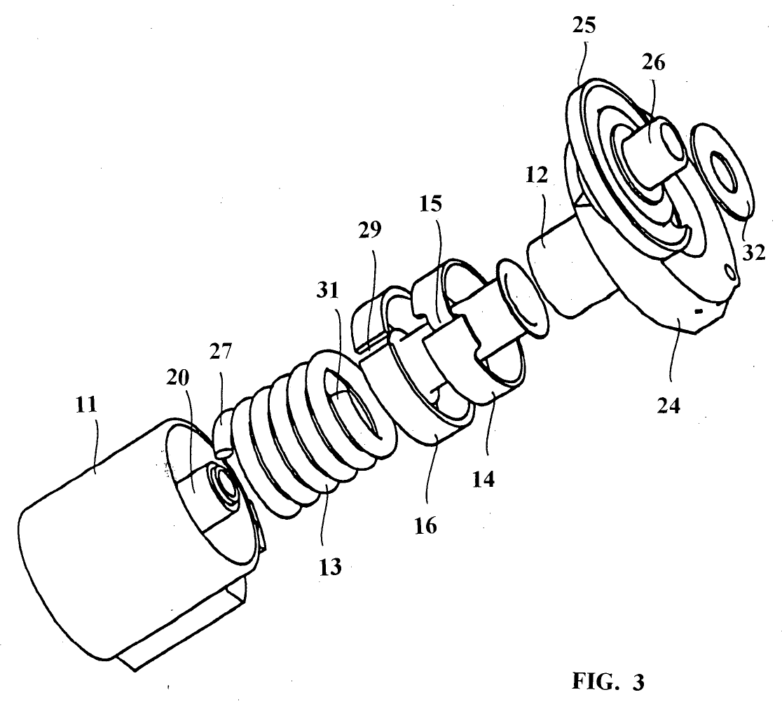

FIGS. 2 and 3 are described jointly below. Details identical to those shown in FIG. 1 have been given the same reference numbers. To that extent, reference is made to the description of FIG. 1. The receiving housing 11 with its cylindrical shape is clearly visible. The hub 12 which, via a bearing sleeve 19, is supported on a journal 20 inserted into the housing 11. For assembly purposes, the bearing sleeve 19, is axially centrally divided. Screwing and fixing means 21 is provided on the receiving housing 11. Furthermore, the housing 11 is provided with a rotational abutment 22 which cooperates with an inner recess 23 at the cover 24 which is integrally connected to the hub 12. In this way, the housing 11 and the hub 12 are rotatable relative to one another to a limited extent. A roller carrier arm 25 with a bearing journal 26 is integrally formed on to the cover 24 and thus to the hub 12. A tensioning roller can be supported on the bearing journal 26. A disc 32 provides mutual axial security after assembly. By means of a lug 28 formed on to one end 30 of the strip spring 14, the strip spring 14 can be made to engage the cover 24 and thus the hub 12 in the direction of rotation and fixed thereto.

The other free end 15 of the strip spring 14 is bent inwardly. This free end 15 of the strip spring 14 supports the torsion spring 13 on its free end. The second end 27 of the torsion spring 13 rests against the inside of the receiving housing 11 in a rotationally fast way.

The outside of the strip spring 14 is surrounded by the damping sleeve 16 which can be seen to be provided with a circumferential slot 29 dividing the circumference of the sleeve.

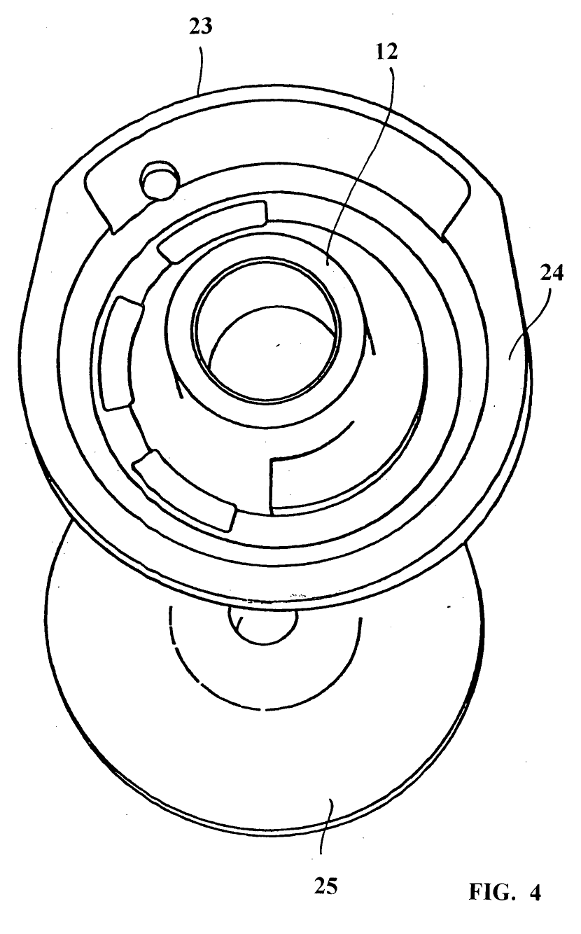

FIG. 4 shows the hub 12 with the formed-on cover 24, with the circumferential recess 23 which forms the rotational abutment with the housing. Furthermore, the tensioning roller arm 25 is shown with an eccentric bearing region for the tensioning roller.

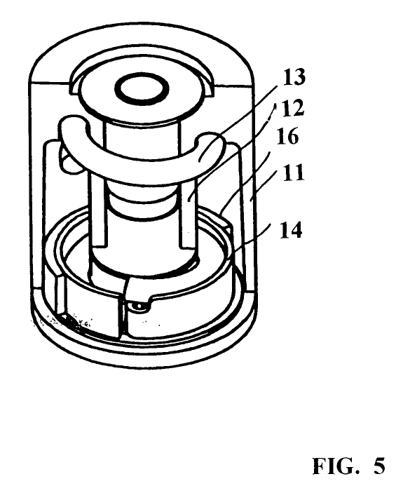

In FIG. 5, details identical to those shown in FIGS. 1 to 4 have been given the same reference numbers. More particularly, in FIG. 5, in partial section, it is possible to see the housing 11, the damping sleeve 16, the strip spring 14, the torsion spring 13 and the hub 12 which are arranged inside one another.

1. A belt tensioning device having a substantially cylindrical receiving housing and a hub coaxially arranged therein, wherein the receiving housing and the hub are supported so as to be rotatable relative to one another as well as supported by a helical torsion spring so as to be pretensioned relative to one another, and having a damping device which comprises a circumferentially slotted damping sleeve and a strip spring adapted to the damping sleeve, said damping sleeve shown resting against the inside of the receiving housing, said strip spring being arranged between the damping sleeve and the torsion spring, said the strip spring and torsion spring being connected in series, wherein one of the two is supported on the receiving housing and the other one of the two on the hub.

2. A device according to claim 1, wherein said receiving housing comprises screwing means and a roller carrier connected to the hub.

3. A device according to claims 1 or 2, wherein said hub is integrally connected to a housing cover which closes said receiving housing.

4. A device according to claims 1 or 2, wherein said strip spring engages said the housing cover by means of a strip spring end.

5. A device according to claims 1 or 2, wherein said strip spring is supported on the free end of said torsion spring by means of its free end which is bent inwardly.

6. A device according to claims 1 or 2, wherein said torsion spring is form-fittingly and positively supported in said receiving housing by means of its one end.

7. A device according to claims 1 or 2, wherein said receiving housing has arranged therein a bearing journal which supports said hub.

8. A device according to claims 1 or 2, wherein said receiving housing has arranged therein a bearing journal which supports said hub and wherein between said bearing journal and said hub there is arranged a bearing bush.

9. A device according to claims 1 or 2, wherein said strip spring engages said housing cover by means of a strip spring end, and wherein said strip spring is supported on the free end of said torsion spring by means of its free end which is bent inwardly.

10. A device according to claims 1 or 2, wherein said strip spring engages said housing cover by means of a strip spring end, and wherein said strip spring is supported on the free end of said torsion spring by means of its free end which is bent inwardly, and wherein said torsion spring is form-fittingly and positively supported in said receiving housing by means of its one end.
